(19) United States
(12) Patent Application Publication
(10) Pub. No.: US 2008/0107311 A1
(43) Pub. Date: May 8, 2008

(54) Method and apparatus for face recognition using extended gabor wavelet features

(75) Inventors: Xiangsheng Huang, Yongin-si (KR); Won-jun Hwang, Seoul (KR); Seok-chaol Kee, Seoul (KR); Young-su Moon, Seoul (KR); Gyu-lee Park, Anyang-si (KR); Jong-ho Lee, Hwaesong-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/797,886

(22) Filed: May 8, 2007

(30) Foreign Application Priority Data
Nov. 8, 2006 (KR) 10-2006-0110170

(51) Int. Cl. G06K 9/00

(52) U.S. Cl. 382/118

(57) ABSTRACT

A face recognition method and apparatus using extended Gabor wavelet features are provided. In the face recognition method, extended Gabor wavelet features are extracted from a face image by applying an extended Gabor wavelet filter, a Gabor wavelet feature set is selected by performing a supervised learning process on the extended Gabor wavelet features, and the selected Gabor wavelet feature set is used for face recognition. Accordingly, it is possible to solve problems of a high error rate of face recognition and low face recognition efficiency caused from a limitation of parameters of the Gabor wavelet filter. In addition, it is possible to solve the problem of increased calculation complexity caused from using an extended Gabor wavelet filter and to implement robust face recognition which is excellent in dealing with a change in expression and illumination.

### CROSS-REFERENCE TO RELATED PATENT APPLICATION

This application claims the benefit of Korean Patent Application No. 10-2006-0110170, filed on Nov. 8, 2006, in the Korean Intellectual Property Office, the disclosure of which is incorporated herein in its entirety by reference.

### BACKGROUND OF THE INVENTION

1. Field of the Invention

The present invention relates to face recognition method and apparatus using Gabor wavelet features, and more particularly, to a face recognition method and apparatus using Gabor wavelet filter boosting learning, and linear discriminant analysis (LDA) learning, which are used for face recognition and verification technologies.

2. Description of the Related Art

Recently, due to frequent occurrence of terror attacks and theft, security solutions using face recognition have become more and more important. There is keen interest in implementing biometric solutions to combat terrorist attacks. An efficient way is to strengthen border security and identity verification. The International Civil Aviation Organization (ICAO) recommends biometric information in machine-readable travel documents (MRTD). Moreover, the U.S. enhanced border security and visa entry reform act mandates the use of biometrics in travel documents, passport, and visas, while boosting biometric equipment and software adoption level. Currently, the biometric passport has been adopted in Europe, the USA, Japan, and some other parts of the world. The biometric passport is a novel passport embedded with a chip, which contains biometric information of the user.

Nowadays, many agencies, companies, or other types of organizations require their employees or visitors to use an admission card for the purpose of identity verification. Thus, each person receives a key card or a key pad that is used in a card reader and must be carried all the time when the person is within designated premises.

In this case, however, when a person loses the key card or key pad or it is stolen, an unauthorized person may access a restricted area and a security problem may thus occur. In order to prevent this situation, biometric systems which automatically recognize or confirm the identity of an individual by using human biometric or behavioral features have been developed. For example, biometric systems have been used in banks, airports, high-security facilities, and so on. Accordingly, lots of research into easier application and higher reliability of biometric systems has been made.

Individual features used in biometric systems include fingerprint, face, palm-print, hand geometry, thermal image, voice, signature, vein shape, typing keystroke dynamics, retina, iris etc. Particularly, face recognition technology is most widely used as an identify verification technology. In face recognition technology images of persons face in a still image or a moving picture are processed by using a face database to verify the identity of a person. Since face image data changes greatly according to pose or illumination, various images of the same person cannot be easily verified as being the same person.

Various image processing methods have been proposed in order to reduce error in face recognition. These conventional face recognition methods are susceptible to errors caused from assumptions of linear distributions and Gaussian distributions.

Particularly, the Gabor wavelet filter used for face recognition is relatively suitable to acquire a change in expression and illumination of a face image. When the face recognition is performed by using the Gabor wavelet features, calculation complexity is increased, so that there is a limitation of the parameters of the Gabor wavelet filter. The use of the Gabor wavelet filter having the limitation causes a high error rate of face recognition and low face recognition efficiency. Moreover, a large change in expression and illumination of a face image may deteriorate the face recognition efficiency.

### SUMMARY OF THE INVENTION

The present invention provides face recognition method and apparatus by restricting parameters of a Gabor wavelet filter in face recognition capable of solving problems of a high error rate, low recognition efficiency, and increase in calculation complexity caused from using an extended Gabor wavelet filter and implementing robust face recognition which is excellent in dealing with a change in expression and illumination.

According to an aspect of the present invention, there is provided a face descriptor generating method comprising: applying an extended Gabor wavelet filter to a training face image to extract Gabor wavelet features from the training face image; performing a face-image-classification supervised learning process on the extracted Gabor wavelet features of the training face image to select the Gabor wavelet features and constructing a Gabor wavelet feature set including the selected Gabor wavelet features; applying the constructed Gabor wavelet feature set to an input face image to extract Gabor wavelet features from the input face image; and generating a face descriptor for face recognition by using the constructed Gabor wavelet feature set and the Gabor wavelet features extracted from the input face image.

According to another aspect of the present invention, there is provided a ace recognition method comprising: applying an extended Gabor wavelet filter to a training face image to extract Gabor wavelet features from the training face image; performing a face-image-classification supervised learning process on the extracted Gabor wavelet features of the training face image to select the Gabor wavelet features and construct a Gabor wavelet feature set including the selected Gabor wavelet features; applying the constructed Gabor wavelet feature set to an input face image and an a target face image to extracted Gabor wavelet features from the input face image and the target face image; generating face descriptors of the input face image and the target face image by using the constructed Gabor wavelet feature set and the Gabor wavelet feature set extracted from the input face image and the target face image; and determining whether or not the generated face descriptors of the input face image and the target face image have a predetermined similarity.

According to another aspect of the present invention, there is provided a face descriptor generating apparatus comprising: a first Gabor wavelet feature extracting unit which applies an extended Gabor wavelet filter to a training face image to extract extended Gabor wavelet features from the training face image; a selecting unit which selects Gabor wavelet features by performing a face-image-classification supervised learning process on the first Gabor wavelet features and generates a Gabor wavelet feature set including the selected Gabor wavelet features; a second Gabor wavelet feature extracting unit which applies the Gabor wavelet feature set to an input image to extract Gabor wavelet features from the input image; and a face descriptor generating unit which generates a face descriptor by using the Gabor wavelet features extracted by the second Gabor wavelet feature extracting unit.

According to another aspect of the present invention, there is provided a face recognition apparatus comprising: a Gabor wavelet feature extracting unit which applies an extended Gabor wavelet filter to a training face image to extract extended Gabor wavelet features from the training face image; a selecting unit which performs a face-image-classification supervised learning process on the extracted Gabor wavelet features to select the Gabor wavelet features and construct a Gabor wavelet feature set including the selected Gabor wavelet features; an input-image Gabor wavelet feature extracting unit which applies the constructed Gabor wavelet feature set to an input image to extract the Gabor wavelet features from the input image; a target-image Gabor wavelet feature extracting unit which applies the constructed Gabor wavelet feature set to a target image to extract the Gabor wavelet features from the target image; a face descriptor generating unit which generates face descriptors of the input image and the target images by using the Gabor wavelet features of the input image and the target image; and a similarity determining unit which determines whether or not the face descriptors of the input image and the target image has a predetermined similarity.

According to another aspect of the present invention, there is provided a computer-readable recording medium having embodied thereon a computer program for the aforementioned face descriptor generating method or face recognition method.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram illustrating a face descriptor generating apparatus according to an embodiment of the present invention;

FIG. 2 is a flowchart illustrating a face descriptor generating method according to an embodiment of the present invention;

FIG. 3 is a detailed flowchart illustrating operation 200 of FIG. 2 according to an embodiment of the present invention;

FIG. 4 is a flowchart illustrating an example of implantation of extended Gabor wavelet features according to operation 200 of FIG. 2 according to an embodiment of the present invention;

FIG. 5 is a detailed flowchart illustrating operation 300 of FIG. 2 according to an embodiment of the present invention;

FIG. 6 is a conceptual view illustrating parallel boosting learning in operation 300 of FIG. 2 according to an embodiment of the present invention;

FIG. 7 is a detailed flowchart illustrating operation 320 of FIG. 5 according to an embodiment of the present invention;

FIG. 8 is a detailed flowchart illustrating operation 400 of FIG. 2 according to an embodiment of the present invention;

FIG. 9 is a detailed flowchart illustrating operation 410 of FIG. 8 according to an embodiment of the present invention;

FIG. 10 is a detailed flowchart illustrating operation 430 of FIG. 8 according to an embodiment of the present invention;

FIG. 11 is a block diagram illustrating a face recognition apparatus according to another embodiment of the present invention; and

FIG. 12 is a flowchart illustrating a face recognition method according to another embodiment of the present invention.

### DETAILED DESCRIPTION OF THE INVENTION

Hereinafter, a face descriptor generating apparatus according to an embodiment of the present invention is described in detail with reference to the accompanying drawings.

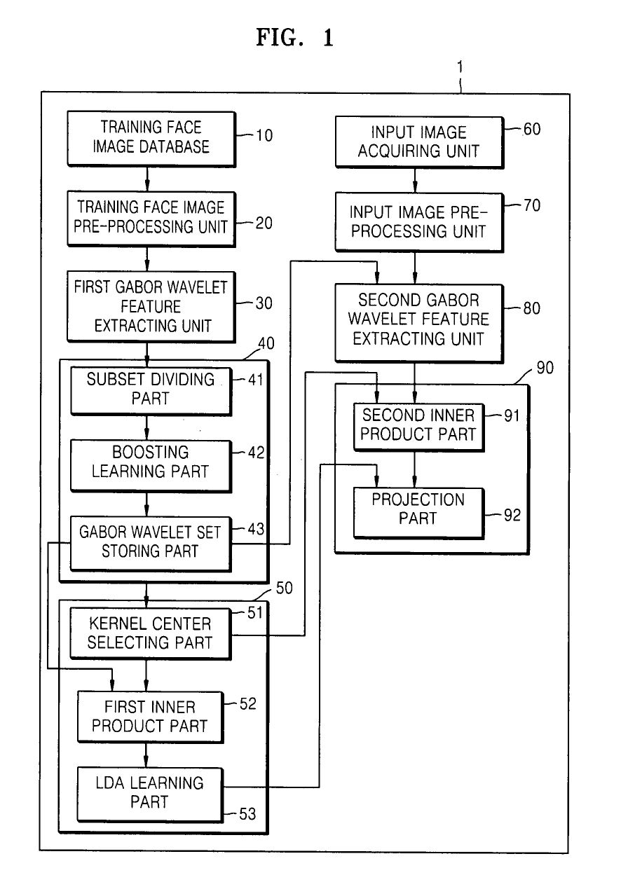

FIG. 1 is a block diagram illustrating a face descriptor generating apparatus according to an embodiment of the present invention.

The face descriptor generating apparatus 1 according to the embodiment includes a training face image database 10, a training face image pre-processing unit 20, a first Gabor wavelet feature extracting unit 30, a selecting part 40, a basis vector generating unit 50, an input image acquiring unit 60, an input image pre-processing unit 70, a second Gabor wavelet feature extracting unit 80, and a face descriptor generating unit 90.

The training face image database 10 stores face image information of persons included in a to-be-identified group. In order to increase face recognition efficiency, face image information of images taken having various expressions, angles, and brightness are needed. The face image information is subject to a predetermined pre-process for generating a face descriptor and, after that, stored in the training face image database 10.

The training face image pre-processing unit 20 performs a predetermined pre-process on all the face images stored in the training face image database 10. The predetermined pre-process for transforming the face image to an image suitable for generating the face descriptor includes operations of removing background regions from the face image, adjusting a magnitude of the image based on the location of eyes, and changing the face image so as to reduce a variation in illumination.

The first Gabor wavelet feature extracting unit 30 applies an extended Gabor wavelet filter to the pre-processed face images to extract extended Gabor wavelet features from the face images. The Gabor wavelet filter is described later.

The selecting unit 40 performs a supervised learning process on the extended Gabor wavelet features to select efficient Gabor wavelet features. The supervised learning is a learning process having a specific goal such as classification and prediction. In the embodiment, the selecting unit 40 performs a supervised learning process having a goal of improving efficiency of class classification (person classification) and identity verification. Particularly, by using a boosting learning method such as a statistical re-sampling algorithm, the efficient Gabor wavelet features can be selected. In addition to the boosting learning method, a bagging learning method and a greedy learning method may be used as the statistical re-sampling algorithm.

The extended Gabor wavelet features are extracted from the first Gabor wavelet feature extracting unit 30 using an extended Gabor wavelet filter. In comparison with conventional Gabor wavelet features, the extended Gabor wavelet features comprise a huge amount of data. Therefore, face recognition and verification using the extended Gabor wavelet features have a problem of requiring a large amount of data-processing time.

The selecting unit 40 includes a subset dividing part 41 for dividing the extended Gabor wavelet features into subsets, a boosting learning part 42 for boosting learning, and a Gabor wavelet set storing part 43. Since the huge extended Gabor wavelet features are divided by the subset dividing part 41, it is possible to reduce the data-processing time. In addition, the boosting learning part 42 performs a parallel boosting learning process on the subset divided from the Gabor wavelet features to select efficient Gabor wavelet features. Since the selected Gabor wavelet features are a result of a parallel selecting process, the selected Gabor wavelet features are complementary to each other, so that it is possible to increase the face recognition efficiency. The boosting learning algorithm is described later. Gabor wavelet set storing part 43 stores a set of the selected efficient Gabor wavelet features.

The basis vector generating unit 50 performs a linear discriminant analysis (LDA) learning process on the set of Gabor wavelet features generated by the selecting unit 40 and generates basis vectors. In order to perform the (kernel) LDA learning process, the basis vector generating unit 50 includes a kernel center selecting part 51, a first inner product part 52, and an LDA learning part 53.

The kernel center selecting part 51 selects at random a kernel center from each of face images selected by the boosting learning process. The first inner product part 52 performs inner product of the kernel center with the Gabor wavelet feature set to generate a new feature vector. The LDA learning part 53 performs an LDA learning process to generate LDA basis vectors from the generated feature vector. The LDA algorithm is described later in detail.

The input image acquiring unit 60 acquires input face images for face recognition. The input image acquiring unit 60 uses an image pickup apparatus (not shown) such a camera and camcorder capable of acquiring the face images of to-be-recognized or to-be-verified persons.

The input image pre-processing unit 70 removes a background region from the input image acquired by the input image acquiring unit 60, filters the background-removed face image by using a Gaussian low pass filter. Next, the input image pre-processing unit 70 searches for the location of the eyes in the face image and normalizes the filtered face image based on the location of the eyes. Next, the input image pre-processing unit 70 changes illumination so as to remove a variation in illumination.

The second Gabor wavelet feature extracting unit 80 applies the extended Gabor wavelet features set as a Gabor filter to the acquired input face image to extract the extended Gabor wavelet features from the input image features.

The face descriptor generating unit 90 generates a face descriptor by using a second Gabor wavelet feature. The face descriptor generating unit 90 includes a second inner product part 91 and a projection part 92. The second inner product part 91 performs inner product of on the kernel center selected by the kernel center selecting part 51 with the second Gabor wavelet feature to generate a new feature vector. The projection part 92 projects the generated feature vector onto a basis vector to generate the face descriptor (face feature vector). The generated face descriptor is used to determine similarity with the face image stored in the training face image database 10 for the purpose of face recognition and identity verification.

Now, a face descriptor generating method according to a embodiment of the present invention is described in detail with reference to the accompanying drawings.

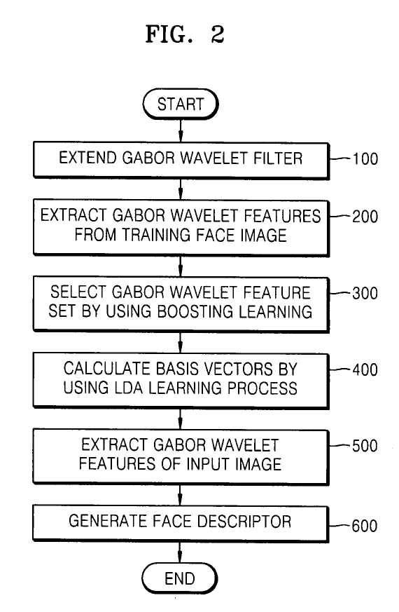

FIG. 2 is a flowchart illustrating a face descriptor generating method according to an embodiment of the present invention.

The face descriptor generating method includes operations which are time-sequentially performed by the aforementioned face descriptor generating apparatus 1.

In operation 100, the first Gabor wavelet feature extracting unit 30 extends the Gabor wavelet filter. In the embodiment, the extended Gabor wavelet filter is used to extract features from face image. By using the Gabor wavelet, a multiple-resolution, multiple-direction filter can be constructed from a singe basic function. A global analysis can be made by a low spatial frequency filter, and a local analysis can be made by a high spatial frequency filter. The Gabor wavelet function is suitable for detecting a change in expression and illumination of a face image. The Gabor wavelet function can be generalized in a two-dimensional form represented by Equation 1.

$${Ψ}_{μ , v} = \frac{{\vert \vec{{k}_{μ , v}} \vert}^{2}}{{σ}_{x} {σ}_{y}} exp ( - \frac{{\vert \vec{{k}_{μ , v}} \vert}^{2} \cdot {\vert \vec{z} \vert}^{2}}{2 {σ}_{x} {σ}_{y}} ) [ exp ( i \vec{{k}_{μ , v}} \cdot \vec{z} ) - exp ( - \frac{{σ}_{x} {σ}_{y}}{2} ) ] \qquad [ Equation 1 ]$$

where, Ψ_{μ, ν} is a Gabor wavelet function representing a plane wave characterized by a vector \vec{z} and enveloped with a Gaussian function, k\vec{_{μ, ν}}=k_{ν}exp(iφ_{μ}), \vec{z}=(x,y) is a vector representing positions of pixels of an image, k_{ν}=kₘₐₓ/ƒ^{ν}, kₘₐₓ is a maximum frequency, ƒ is a spacing factor of \sqrt{2}, φ₈₂ =2πμ/8, μ is an orientation of Gabor kernel, ν is a scale parameter of Gabor kernel, and σₓ and σ_{y} are standard deviations of the Gaussian envelope in x-axis and y-axis directions.

By taking into consideration the calculation complexity and performance of the conventional Gabor wavelet function, the scale parameter ν is limited to 5 values (“5” denotes that ν has 5 values, so that ν∈ {0, 1, 2, 3, 4}). However, according to the present invention, the scale parameter ν can be extended to be 5 to 15 values (“5 to 15” denotes that ν have 5 to 15 values, so that ν ∈ {0, 1, 2, 3, 4, 5, 6, 7, 8, 9, 10, 11, 12, 13, 14}). In general, the parameters σₓ and σ_{y} have the same standard deviation in the x-axis and y-axis directions. However, according to the present invention, the parameters σₓ and σ_{y} have different standard deviations. Each of the standard deviations is extended to have a value of 0.75π to 2π. In addition, kₘₐₓ is extended from π/2 to a range of π/2 to π.

Conventionally, the use of the Gabor wavelet function or the extended Gabor wavelet filter causes increase in calculation complexity. As such, the extended Gabor wavelet filter has not been used. However, according to the present invention, a boosting learning process is performed on the features extracted by using the extended Gabor wavelet filter, so that efficient features can be selected. Therefore, it is possible to solve the problem of the increase in calculation complexity.

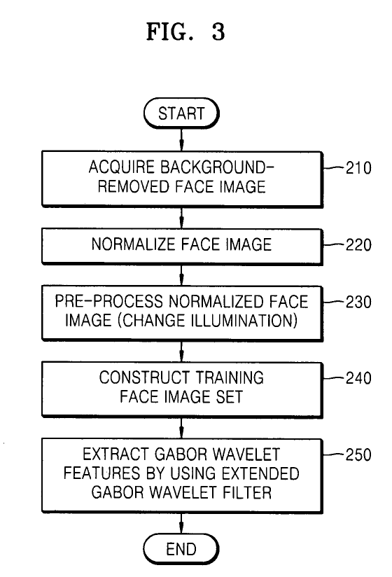

In operation 200, the First Gabor wavelet feature extracting unit 30 applies an extended Gabor wavelet filter to the training face image which is subjected to the pre-processes of the training face image pre-processing unit 20 to extract extended Gabor wavelet features. Before operation 200, the face image may be normalized by using a predetermined pre-process. The Gabor wavelet feature extracting operation further including the pre-process of the face image normalization is shown in FIG. 3.

In operation 200, the first Gabor wavelet feature extracting unit 30 applies the extended Gabor wavelet filter to the face image in a rotational manner to extract extended Gabor wavelet features. The Gabor wavelet feature is constructed as a convolution of the Gabor kernel and the face feature. The extended Gabor wavelet features are used as input data of the kernel LDA learning part 53.

FIG. 3 is a detailed flowchart illustrating operation 200 of FIG. 2.

In operation 210, the training face image pre-processing unit 20 removes background regions from face images.

In operation 220, the training face image pre-processing unit 20 normalizes the face image by adjusting the size of the background-removed face image based on the location of eyes. For example, a margin-removed face image may be normalized with 120×160 [pixels]. The training face image pre-processing unit 20 performs filtering of the face image by using the Gaussian low pass filter to obtain a noise-removed face image.

In operation 230, the training face image pre-processing unit 20 performs an illumination pre-process on the normalized face image so as to reduce a variation in illumination. The variation in illumination of the normalized face image causes deterioration in face recognition efficiency, so that the variation in illumination is required to be removed. For example, a delighting light reduction algorithm may be used to remove the variation in illumination of the normalized face image.

In operation 240, the training face image pre-processing unit 20 constructs a training face image set which can be used for descriptor generation and face recognition.

In operation 250, the first Gabor wavelet feature extracting unit 30 applies the extended Gabor wavelet filter of operation 100 to the training face images to extract the Gabor wavelet features from the training face images. For example, when a magnitude of the face image is 120×160 [pixels], the number of the extended Gabor wavelet features is 120 (width)×160 (height)×8 (orientations)×10 (scales)×3 (σₓ1.5π, σ_{y}=0.75π; σₓπ, σ_{y}π; σₓ=0.75π, and σ_{y}=1.5π)×(magnitude and phase).

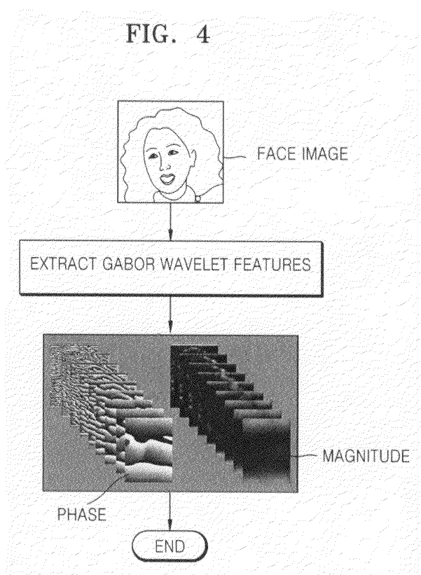

FIG. 4 is a flowchart illustrating an example of implantation of extended Gabor wavelet features according to operation 200 of FIG. 2.

As shown in FIG. 4, the pre-processed face image information is input into the extended Gabor wavelet filter. By performing a Gabor wavelet filtering process, the real and imaginary values satisfying the following equations can be obtained from the pre-processed face image information.

A real filter of the extended Gabor wavelet filter may be defined by Equation 2.

$$Re ( {Ψ}_{μ , v} ) = \frac{{\vert \vec{{k}_{μ , v}} \vert}^{2}}{{σ}_{x} {σ}_{y}} exp ( - \frac{{\vert \vec{{k}_{μ , v}} \vert}^{2} \cdot {\vert \vec{z} \vert}^{2}}{2 {σ}_{x} {σ}_{y}} ) [ cos ( i \vec{{k}_{μ , v}} \cdot \vec{z} ) - exp ( - \frac{{σ}_{x} {σ}_{y}}{2} ) ] \qquad [ Equation 2 ]$$

An imaginary filter of the extended Gabor wavelet filter may be defined by Equation 3.

$$Im ( {Ψ}_{μ , v} ) = \frac{{\vert \vec{{k}_{μ , v}} \vert}^{2}}{{σ}_{x} {σ}_{y}} exp ( - \frac{{\vert \vec{{k}_{μ , v}} \vert}^{2} \cdot {\vert \vec{z} \vert}^{2}}{2 {σ}_{x} {σ}_{y}} ) sin ( i \vec{{k}_{μ , v}} \cdot \vec{z} ) \qquad [ Equation 3 ]$$

The real and imaginary values obtained by the real and imaginary filters are transformed into a Gabor wavelet feature having a magnitude feature and a phase feature. The magnitude feature and the phase feature are defined by Equations 4 and 5, respectively.

$$\begin{matrix}M = \sqrt{{Re}^{2} ( {Ψ}_{μ , v} ) + {Im}^{2} ( {Ψ}_{μ , v} )} & [ Equation 4 ] \\ P = {tan}^{- 1} [ ( Re ( {Ψ}_{μ , v} ) ) / ( Im ( {Ψ}_{μ , v} ) ) ] & [ Equation 5 ]\end{matrix}$$

Referring again to FIG. 2, in operation 300, the selecting unit 40 selects efficient Gabor wavelet features from the extended Gabor wavelet features extracted from the first Gabor wavelet feature extracting unit by using a boosting learning process which is a statistical re-sampling algorithm so as to construct a Gabor wavelet feature set.

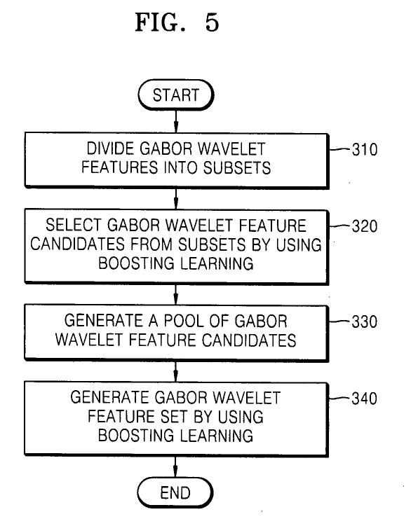

FIG. 5 is a detailed flowchart illustrating operation 300 of selecting a Gabor wavelet feature set suitable for face image classification using the boosting learning process described with reference to FIG. 2 according to an embodiment of the present invention;

Since the Gabor wavelet features are extracted by using the extended Gabor wavelet filter in operation 200, there is a problem in that the number of the Gabor wavelet features is too large. According to the embodiment, in operation 300, efficient Gabor wavelet features for face recognition are extracted by using the boosting learning process, so that it is possible to reduce the calculation complexity.

In operation 310, the subset dividing part 41 divides the Gabor wavelet features into subsets. The number of the huge extended Gabor wavelet features extracted in operation 200 is 9,216,000 (=120×160×8×10×3×2). The huge extended Gabor wavelet features are divided into 20 subsets by the subset dividing part 41 in operation 310. Namely, each subset includes 460,800 Gabor wavelet features.

In operation 320, the boosting learning part 42 selects Gabor wavelet feature candidates from the subsets by using the boosting learning process. By using the Gabor wavelet features of “intra person” and “extra person”, a multi-class face recognition task for multiple persons can be transformed into a two-class face recognition task for “intra person” or “extra person”, wherein one class corresponds to one person. Here, the “intra person” denotes a face image group acquired from a specific person, and the “extra person” denotes a face image group acquired from other persons excluding the specific person. A difference of values of the Gabor wavelet features between the “intra person” and the “extra person” can be used as a criterion for classifying the “intra person” and the “extra person”. By combining all the to-be-trained Gabor wavelet features, intra and extra-personal face image pairs can be generated. Before the boosting learning process, a suitable number of the face image pairs can be selected from the subsets. For example, 10,000 intra and extra-personal face image pairs may be selected at random.

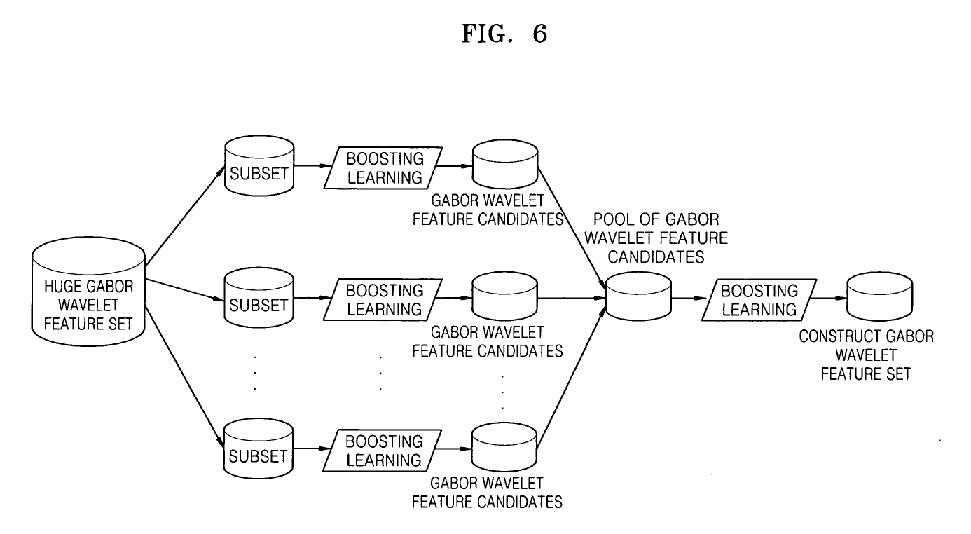

FIG. 6 is a conceptual view illustrating a parallel boosting learning process performed in operation 300 of FIG. 2.

The process for selecting the efficient candidate Gabor wavelet features for face recognition from the subsets in parallel is an important mechanism for distributed computing and speedy statistical learning.

For example, the boosting learning process is performed on 10,000 intra and extra-personal face image feature pairs, so that 2,000 intra and extra-personal face image feature pairs can be selected as Gabor wavelet feature candidates.

In operation 330, the Gabor wavelet feature candidates selected from the subsets in operation 320 are collected to generate a pool of new Gabor wavelet feature candidates. In the embodiment, since the number of subsets is 20, a pool of new Gabor wavelet feature candidates including 40,000 intra and extra-personal face image feature pairs can be generated. Next, the boosting learning process is performed on the 40,000 intra and extra-personal face image feature pairs, so that more efficient Gabor wavelet features can be selected.

In operation 340, the boosting learning part 42 performs the boosting learning process on the pool of the new Gabor wavelet feature candidates generated in operation 330 to generate a Gabor wavelet feature set.

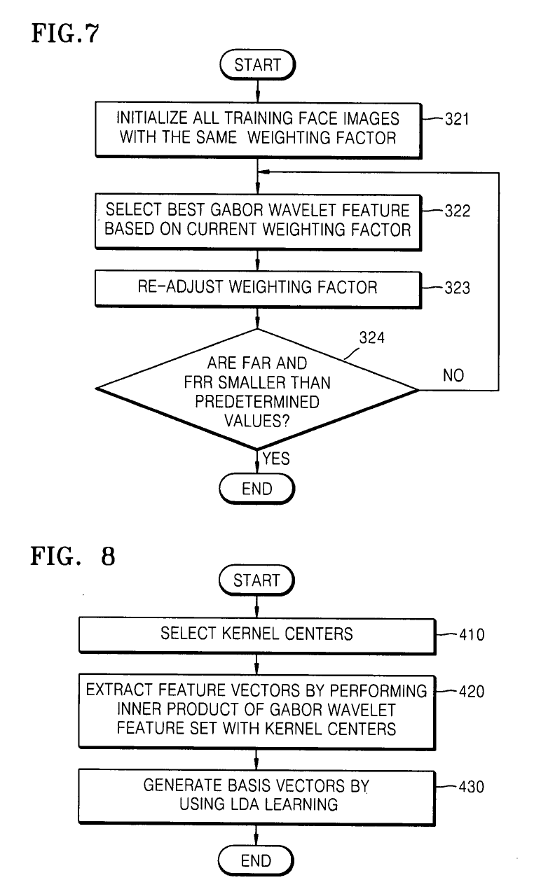

FIG. 7 is a detailed flowchart illustrating the boosting learning process performed in operations 320 and 340 of FIG. 2 according to an embodiment of the present invention.

In operation 321, the boosting learning part 42 initializes all the training face images with the same weighting factor before the boosting learning process.

In operation 322, the boosting learning part 42 selects the best Gabor wavelet feature in terms of a current distribution of the weighting factors. In other words, the Gabor wavelet features capable of increasing the face recognition efficiency are selected from the Gabor wavelet features of the subsets. As a coefficient associated with the face recognition efficiency, there is a verification ratio (VR). The Gabor wavelet feature may be selected based on the VR.

In operation 323, the boosting learning part 42 adjusts the weighting factors of the all the training face image by using the selected Gabor wavelet features. More specifically, the weighting factors of unclassified samples of the training face images are increased, and the weighting factors of classified samples thereof are decreased.

In operation 324, when the selected Gabor wavelet feature does not satisfy a false acceptance rate (FAR) (for example, 0.0001) and a false reject rate (FRR) (for example, 0.01), the boosting learning part 42 selects another Gabor wavelet feature based on a current distribution of weighting factors to adjust the weighting factors of all the training face images. The FAR is a recognition error rate representing how often a false person is accepted as the true person, and the FRR is another recognition error rate representing how often the true person is rejected as a false person.

As a conventional boosting learning method, there are AdaBoost, GentleBoost, realBoost, KLBoost, and JSBoost learning methods. By selecting complementary Gabor wavelet features from the subsets by using a boosting learning process, it is possible to increase face recognition efficiency.

FIG. 8 is a detailed flowchart illustrating a process for calculating the basis vector by using the LDA referred to in the description of FIG. 2. The LDA is a method of extracting of a linear combination of variables, investigating the influence of new variables of the linear combination on an array of groups, and re-adjusting weighting factors of the variables so as to search for a combination of features capable of most efficiently classifying two or more classes. As an example of the LDA method, there is a kernel LDA learning process and a Fisher LDA method. In the embodiment, face recognition using the kernel LDA learning process is exemplified.

In operation 410, the kernel center selecting part 51 selects at random a kernel center of each of the extracted training face images according to the result of the boosting learning process.

In operation 420, the inner product part 52 performs inner product of the Gabor wavelet feature set with the kernel centers to generate feature vectors. A kernel function for performing an inner product calculation is defined by Equation 6.

$$k ( x , {x}^{′} ) = exp ( - \frac{{‖ x - {x}^{′} ‖}^{2}}{2 {σ}^{2}} ) \qquad [ Equation 6 ]$$

where x′ is one of the kernel centers, and x is one of the training samples. A dimension of new feature vectors of the training samples is equal to a dimension of representative samples.

In operation 430, the LDA learning part 53 generates LDA basis vectors from the feature vectors extracted through the LDA learning.

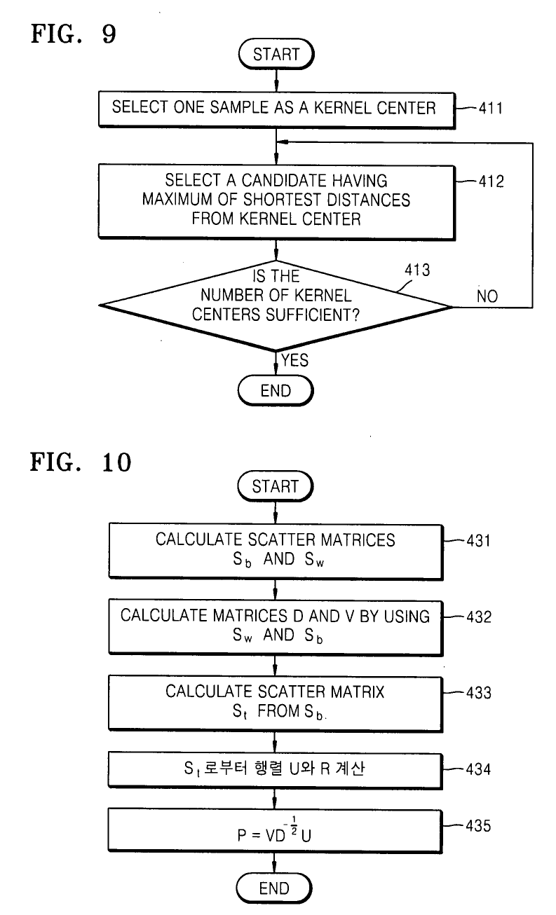

FIG. 9 is a detailed flowchart illustrating operation 410 of FIG. 8 according to an embodiment of the present invention. An algorithm shown in FIG. 9 is a sequential forward selection algorithm which includes the flowing operations.

In operation 411, the kernel center selecting part 51 selects at random one sample among all the training face images of one person in order to find a representative sample, that is, the kernel center.

In operation 412, the kernel center selecting part 51 selects one image candidate from other face images excluding the kernel center so that the minimum distance between candidate and selected samples is the maximum. The selection of the face image candidates may be defined by Equation 7.

$$c = {max}_{c ∈ S} {min}_{k ∈ K} ( d ( c , k ) ) \qquad [ Equation 7 ]$$

where K denotes the selected representative sample, that is, the kernel center, and S denotes other samples.

In operation 413, it is determined whether or not the number of the kernel centers is sufficient. If the number of the kernel centers is not determined to be sufficient in operation 413, the process for selecting the representative sample is repeated until the sufficient number of the kernel centers is obtained. Namely, operations 411 to 413 are repeated. The determination of the sufficient number of the kernel centers may be performed by comparing the VR with a predetermined reference value. For example, 10 kernel centers for one person may be selected, and the training sets for 200 persons may be prepared. In this case, about 2,000 representative samples (kernel centers) are obtained, and the dimension of the feature vectors obtained in operation 420 is equal to the dimension of the representative samples, that is, 2,000.

FIG. 10 is a detailed flowchart illustrating operation 430 of FIG. 8 according to an embodiment of the present invention. In the LDA learning process, data can be linearly projected onto a subspace having a reduced within-class scatter and a maximized between-class scatter. The LDA basis vector generated in operation 430 represents features of a to-be-recognized group to be efficiently used for face recognition of person of the group. The LDA basis vector can be obtained as follows.

In operation 431, a within-class scatter matrix S_{w} representing within-class variation and a between-class scatter matrix S_{b} representing a between-class variation can be calculated by using all the training samples having new feature vector. The scatter matrices are defined by Equation 8.

$${S}_{B} = {\sum }_{c = 1}^{C} {{M}_{c} [ {μ}_{c} - μ ] [ {μ}_{c} - μ ]}^{T} \\ {S}_{W} = {\sum }_{c = 1}^{C} {\sum }_{x ∈ {χ}_{c}} {[ x - {μ}_{c} ] [ x - {μ}_{c} ]}^{T} \qquad [ Equation 8 ]$$

where, the training face image set is constructed with C number of classes, x denotes a data vector, that is, a component of the c-th class X_{c}, and the c-th class X_{c} is constructed with M_{c} data vectors. In addition, μ_{c} denotes an average vector of the c-th class, and μ denotes an average vector of the overall training face image set.

In operation 432, scatter matrix S_{w} is decomposed into an eigen value matrix D and an eigen vector matrix V, as shown in Equation 9.

$${D}^{- \frac{1}{2}} {V}^{T} {S}_{w} {VD}^{- \frac{1}{2}} = I \qquad [ Equation 9 ]$$

In operation 433, a matrix Sₗ can be obtained from the between-class scatter matrix S_{b} by using Equation 10.

$${D}^{- \frac{1}{2}} {V}^{T} {S}_{b} {VD}^{- \frac{1}{2}} = {S}_{t} \qquad [ Equation 10 ]$$

In operation 434, the matrix Sₗ is decomposed into an eigen vector matrix U and an eigen value matrix R by using Equation 11.

U^{T}S,U=R [Equation 11]

In operation 434, basis vectors can be obtained by using Equation 12.

$$P = {VD}^{- \frac{1}{2}} U \qquad [ Equation 12 ]$$

In operation 500, the second Gabor wavelet feature extracting unit 80 applies the Gabor wavelet set to the input image to extract Gabor wavelet features from the input image.

Although not shown in FIG. 2, operation 500 further includes operations of acquiring the input image and pre-processing the input image. The pre-processing operations are the same as the aforementioned operations 200 and 300. The Gabor wavelet features of the input image can be extracted by applying the Gabor wavelet feature set selected in operation 300 to the pre-processed input image.

In operation 600, the face descriptor generating unit 90 generates the face descriptor by performing projection of the Gabor wavelet features extracted in operation 500 onto the basis vectors.

In operation 600, the second inner product part 91 generates a new feature vector by performing inner product of the Gabor wavelet features extracted in operation 500 with the kernel center selected by the kernel center selecting part 51. The projection part 92 generates the face descriptor by projecting the new feature vector onto the basis vectors.

Now, a face recognition apparatus and method according to other embodiments of the present invention are described in detail with reference to the accompanying drawings.

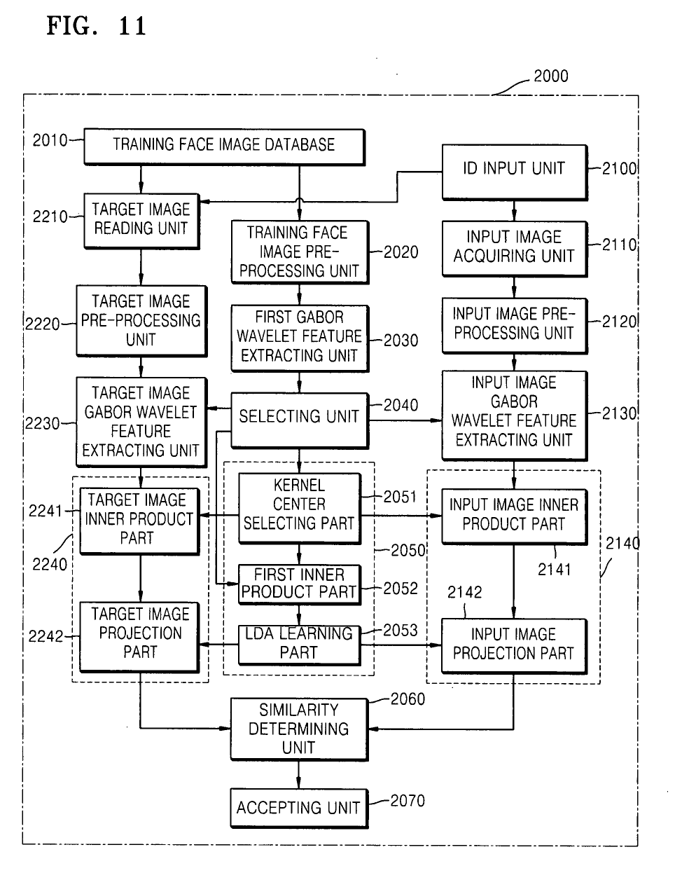

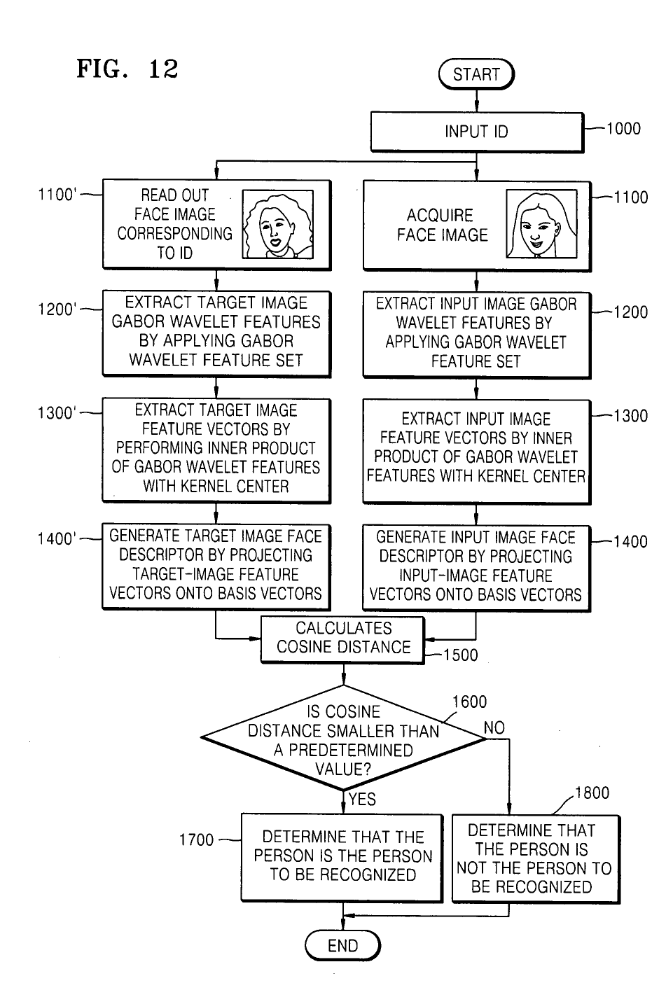

FIG. 11 is a block diagram illustrating a face recognition apparatus according to another embodiment of the present invention.

The face recognition apparatus 2000 includes a training face image database 2010, a training face image pre-processing unit 2020, a first Gabor wavelet feature extracting unit 2030, a selecting unit 2040, a basis vector generating unit 2050, a similarity determining unit 2060, a accepting unit 2070, an ID input unit 2100, an input image acquiring unit 2110, an input image pre-processing unit 2120, an input-image Gabor wavelet feature extracting unit 2130, an input-image face descriptor generating unit 2140, a target image reading unit 2210, a target image pre-processing unit 2220, a target-image Gabor wavelet feature extracting unit 2230, and a target-image face descriptor generating unit 2240.

The components 2010 to 2050 shown in FIG. 11 correspond to the components shown in FIG. 1, and thus, redundant description thereof is omitted.

The ID input unit 2100 receives ID of a to-be-recognized (or to-be-verified) person.

The input image acquiring unit 2110 acquires a face image of the to-be-recognized person by using an image pickup apparatus such as a digital camera.

The target image reading unit 2210 reads out a face image corresponding to the ID received by the ID input unit 2110 from the training face image database 2010. The image pre-processes performed by the input image pre-processing unit 2120 and the target image pre-processing unit 2220 are the same as the aforementioned image pre-processes.

The input-image Gabor wavelet feature extracting unit 213 applies the Gabor wavelet feature set to the input image to extract the Gabor wavelet features from the input image. The Gabor wavelet feature set is previously subject to the boosting learning process and stored in the selecting unit 2040.

The input image inner product part 2141 performs inner product of the Gabor wavelet features extracted from the input image with the kernel center to generate feature vectors of the input image. The target image inner product part 2241 performs inner product of the Gabor wavelet features extracted from the target image with the kernel center to generate feature vectors of the target image feature. The kernel center is previously selected by a kernel center selecting part 2051.

The input image projection part 2142 generates a face descriptor of the input image by projecting the feature vectors of the input image onto the basis vectors. The target image projection part 2242 generates a face descriptor of the target image by projecting the feature vectors of the target image onto the basis vectors. The basis vector is previously generated by an LDA learning process of the LDA learning part 2053.

The face descriptor similarity determining unit 2060 determines a similarity between the face descriptors of the input image and the target image generated by the input image projection part 2142 and the target image projection part 2242. The similarity can be determined based on a cosine distance between the face descriptors. In addition to the cosine distance, Euclidean distance and Mahalanobis distance may be used for face recognition.

If the ID-inputting person is determined to be the same person in the face descriptor similarity determining unit 2050, the accepting unit 2060 accepts the ID-inputting person. If not, the face image may be picked up again, or the ID-inputting person may be rejected.

FIG. 12 is a flowchart illustrating a face recognition method according to another embodiment of the present invention. The face recognition method according to the embodiment includes operations which are time-sequentially performed by the face recognition apparatus 2000.

In operation 1000, the ID input unit 2100 receives ID of a to-be-recognized (or to-be-verified) person.

In operation 1100, the input image acquiring unit 2110 acquires a face image of the to-be-recognized person. Operation 1100 is an operation of reading out the face image corresponding to the ID received in operation 1000 from the training face image database 2010.

In operation 1200, the input-image Gabor wavelet feature extracting unit 2130 extracts the Gabor wavelet features from the input face image. Before operation 1200, the face image acquired in operation 1100 may be subject to the pre-process of FIG. 3. In operation 1200, the input-image Gabor wavelet feature extracting unit 2130 extracts the Gabor wavelet features of the input face image by applying the extended Gabor wavelet feature set generated by the selecting unit as a Gabor filter to the pre-processed input face image.

In operation 1200′, the target-image Gabor wavelet feature extracting unit 2230 extracts target-image Gabor wavelet features by applying the Gabor wavelet feature set as a Gabor filter to the face image which is selected according to the ID and subject to the pre-process. In a case where the target-image Gabor wavelet features are previously stored in the training face image database 2010, operation 1200′ is not needed.

In operation 1300, the input image inner product part 2141 performs inner product of the Gabor wavelet features of the input image with the kernel center selected by the kernel center selecting part 2030 to calculate the feature vectors of the input image. Similarly, in operation 1300′, the target image inner product part 2241 performs inner product of the Gabor wavelet features of the target image with the kernel center to calculate the feature vectors of the target image.

In operation 1400, the input image projection part 2142 generates a face descriptor of the input image by projecting the feature vectors calculated in operation 1300 onto the LDA basis vectors. Similarly, in operation 1400′, the target image projection part 2242 generates a face descriptor of the target image by projecting the feature vectors of the target image onto the LDA basis vectors.

In operation 1500, a cosine distance calculating unit (not shown) calculates a cosine distance between the face descriptors of the face image and the target image. The cosine distance between the two face descriptors calculated in operation 1500 are used for face reorganization and face verification. In addition to the cosine distance, Euclidean distance and Mahalanobis distance may be used for face recognition.

In operation 1600, if the cosine distance calculated in operation 1500 is smaller than a predetermined value, the similarity determining unit 2060 determines that the to-be-recognized person is the same person (operation 1700). If not, the similarity determining unit 2060 determines that the to-be-recognized person is not the same person (operation 1800), and the face recognition ends.

The invention can also be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

According to the present invention, a face descriptor is generated by using huge extended Gabor wavelet features extracted from a face image, and the face descriptor is used for face recognition. Accordingly, it is possible to reduce errors in face recognition (or identity verification) caused from a change in expression, pose, and illumination of the face image. In addition, it is possible to increase face recognition efficiency. According to the present invention, only specific features can be selected from the huge extended Gabor wavelet features by performing a supervised learning process, so that it is possible to solve a problem of calculation complexity caused from the huge extended Gabor wavelet features which comprise a huge amount of data. In addition, according to the present invention, the Gabor wavelet features can be selected by performing a parallel boosting learning process on the huge extended Gabor wavelet features, so that complementary Gabor wavelet features can be selected. Accordingly, it is possible to further increase the face recognition efficiency.

While the present invention has been particularly shown and described with reference to exemplary embodiments thereof, it will be understood by those skilled in the art that various changes in form and details may be made therein without departing from the spirit and scope of the invention as defined by the following claims.

What is claimed is:

1. A face descriptor generating method comprising:
(a) applying an extended Gabor wavelet filter to a training face image to extract Gabor wavelet features from the training face image;
(b) performing a supervised learning process face-image-classification on the extracted Gabor wavelet features of the training face image to select the Gabor wavelet features and constructing a Gabor wavelet feature set including the selected Gabor wavelet features;
(c) applying the constructed Gabor wavelet feature set to an input face image to extract Gabor wavelet features from the input face image; and
(d) generating a face descriptor for face recognition by using the constructed Gabor wavelet feature set and the Gabor wavelet features extracted from the input face image.

2. The face descriptor generating method of claim 1, wherein (d) comprises:
(d1) performing a linear discriminant analysis (LDA) learning process by using the constructed Gabor wavelet feature set to generate basis vectors; and
(d2) generating the face descriptor by using the Gabor wavelet features of the input face image extracted in (c) and the generated basis vectors.

3. The face descriptor generating method of claim 1,
wherein (b) further comprises dividing the extracted Gabor wavelet features of the training face image into subsets, and
wherein the performing of the supervised learning process is embodied by performing a parallel boosting learning process on the divided subsets.

4. The face descriptor generating method of claim 1, wherein (a) comprises:
(a1) removing a background region from the training face image;
(a2) extending parameters of a Gabor wavelet filter to acquire an extended Gabor wavelet filter; and
(a3) applying the acquired extended Gabor wavelet filter to the background-removed training face image of (a1) to extract the Gabor wavelet features thereof.

5. The face descriptor generating method of claim 1,
wherein the extended Gabor wavelet filter satisfies the following equation
$${Ψ}_{μ , v} = \frac{{\vert \vec{{k}_{μ , v}} \vert}^{2}}{{σ}_{x} {σ}_{y}} exp ( - \frac{{\vert \vec{{k}_{μ , v}} \vert}^{2} \cdot {\vert \vec{z} \vert}^{2}}{2 {σ}_{x} {σ}_{y}} ) [ exp ( i \vec{{k}_{μ , v}} \cdot \vec{z} ) - exp ( - \frac{{σ}_{x} {σ}_{y}}{2} ) ] , \qquad$$
and
wherein Ψ_{μ, ν} is a Gabor wavelet function, k\vec{_{μ,ν}}=k_{ν}exp(iφ_{μ}), \vec{z}is a vector representing positions of pixels of an image, k_{ν}=kₘₐₓ/ƒ^{ν}, kₘₐₓ is a maximum frequency in a range of π/2 to π, ƒ is a spacing factor of \sqrt{2}, φ₈₂ =2πμ/8, μ is an orientation of Gabor kernel, ν is a scale parameter of Gabor kernel in a range of 5 to 10, and σₓ and σ_{y} are standard deviations in x-axis and y-axis directions, respectively, which are different from each other.

6. The face descriptor generating method of claim 4, further comprising, between (a1) and (a2),
(a11) filtering the face image by using a Gaussian low pass filter;
(a12) searching for the location of eyes in the filtered face image;
(a13) normalizing the face image based on the location of the eyes; and
(a14) changing illumination to remove a variation in illumination.

7. The face descriptor generating method of claim 1, wherein (b) comprises:
(b1) dividing the extended Gabor wavelet features extracted in (a) into subsets;
(b2) performing a parallel boosting learning process on the divided subsets to select Gabor wavelet feature candidates for lowering an FAR (false accept rate) or an FRR (false reject rate) below predetermined values;
(b3) collecting the Gabor wavelet feature candidates selected from the subsets to generate a pool of Gabor wavelet features; and
(b4) performing the parallel boosting learning process on the generated pool of Gabor wavelet features to select Gabor wavelet features for lowering the FAR or the FRR below predetermined values and constructing the Gabor wavelet feature set including the selected Gabor wavelet features.

8. The face descriptor generating method of claim 2, wherein (d1) comprises:
(d11) selecting kernel centers from the Gabor wavelet feature set;
(d12) generating feature vectors by performing inner product of the Gabor wavelet feature sets with the kernel centers; and
(d13) performing a linear discriminant analysis learning process on the feature vectors generated in (d12) to generate basis vectors.

9. The face descriptor generating method of claim 8, wherein (d11) comprises:
(d111) selecting one Gabor wave feature from the Gabor wavelet feature set as a kernel center;
(d112) selecting a Gabor wavelet feature candidate from the Gabor wavelet feature set excluding the Gabor wave feature selected as a kernel center so that the minimum distance between candidate and kernel center is the maximum; and
(d113) determining whether or not the number of kernel centers is sufficient,
wherein (d111) to (d113) are selectively repeated according to the result of determination of (d113).

10. The face descriptor generating method of claim 8, wherein (d13) comprises:
calculating a between-class scatter matrix and a within-class scatter matrix from the feature vectors obtained in (d12); and
generating LDA basis vectors by using the between-class scatter matrix and the within-class scatter matrix.

11. The face descriptor generating method of claim 8, further comprising performing inner product of the Gabor wavelet features of the input image extracted in (c) with the kernel center of (d11) to generate the feature vectors,
wherein (d2) comprises performing projection of the feature vectors generated by performing the inner product of the Gabor wavelet feature of the input image extracted in (c) with the kernel center of (d11) onto the basis vectors to generate the face descriptor.

12. A computer-readable recording medium having embodied thereon a computer program for the face descriptor generating method of claim 1.

13. A face recognition method comprising:
(a) applying an extended Gabor wavelet filter to a training face image to extract Gabor wavelet features from the training face image;
(b) performing a supervised learning process for face-image-classification on the extracted Gabor wavelet features of the training face image to select the Gabor wavelet features and construct a Gabor wavelet feature set including the selected Gabor wavelet features;
(c) applying the constructed Gabor wavelet feature set to an input face image and a target face image to extract Gabor wavelet features from the input face image and the target face image;
(d) generating face descriptors of the input face image and the target face image by using the constructed Gabor wavelet feature set of (b) and the Gabor wavelet feature set extracted from the input face image and the target face image; and
(e) determining whether or not the generated face descriptors of the input face image and the target face image have a predetermined similarity.

14. The face recognition method of claim 13, wherein (d) comprises:
(d1) performing a LDA learning process by using the constructed Gabor wavelet feature set to generate basis vectors; and
(d2) generating the face descriptors by using the Gabor wavelet features of the input face image and the target face image extracted in (c) and the generated basis vectors.

15. The face recognition method of claim 13,
wherein (b) further comprises dividing the extracted Gabor wavelet features of the training face image into subsets; and
wherein the performing of the supervised learning process is performing a parallel boosting learning process on the divided subsets.

16. The face recognition method of claim 13,
wherein the extended Gabor wavelet filter satisfies the following equation
$${Ψ}_{μ , v} = \frac{{\vert \vec{{k}_{μ , v}} \vert}^{2}}{{σ}_{x} {σ}_{y}} exp ( - \frac{{\vert \vec{{k}_{μ , v}} \vert}^{2} \cdot {\vert \vec{z} \vert}^{2}}{2 {σ}_{x} {σ}_{y}} ) [ exp ( i \vec{{k}_{μ , v}} \cdot \vec{z} ) - exp ( - \frac{{σ}_{x} {σ}_{y}}{2} ) ] ,$$
and
wherein Ψ_{μ, ν} is a Gabor wavelet function, k\vec{_{μ,ν}}=k_{ν}exp(iφ_{μ}), \vec{z}is a vector representing positions of pixels of an image, k_{ν}=kₘₐₓ/ƒ^{ν}, kₘₐₓ is a maximum frequency in a range of π/2 to π, ƒ is a spacing factor of \sqrt{2}, φ₈₂ =2πμ/8, μ is an orientation of Gabor kernel, ν is a scale parameter of Gabor kernel in a range of 5 to 10, and σₓ and σ_{y} are standard deviations in x-axis and y-axis directions, which are different from each other.

17. The face recognition method of claim 13, wherein (b) comprises:
(b1) dividing the extended Gabor wavelet features extracted in (a) into subsets;
(b2) performing a parallel boosting learning process on the divided subsets to select Gabor wavelet feature candidates for lowering an FAR (false accept rate) or an FRR (false reject rate) below predetermined values;
(b3) collecting the Gabor wavelet feature candidates selected from the subsets to generate a pool of Gabor wavelet features; and
(b4) performing the boosting learning process on the generated pool of Gabor wavelet features to select Gabor wavelet features for lowering the FAR or the FRR below predetermined values and constructing the Gabor wavelet feature set including the selected Gabor wavelet features.

18. The face recognition method of claim 14, wherein (d1) comprises:
(d11) selecting kernel centers from the Gabor wavelet feature set;
(d12) generating feature vectors by performing inner product of the Gabor wavelet feature sets with the kernel centers; and
(d13) performing a LDA learning process on the feature vectors generated in (d12) to generate basis vectors.

19. A computer-readable recording medium having embodied thereon a computer program for the face recognition method of claim 13.

20. A face descriptor generating apparatus comprising:
a first Gabor wavelet feature extracting unit which applies an extended Gabor wavelet filter to a training face image to extract extended Gabor wavelet features from the training face image;
a selecting unit which selects Gabor wavelet features by performing a supervised learning process for face-image-classification on the first Gabor wavelet features and generates a Gabor wavelet feature set including the selected Gabor wavelet features;
a second Gabor wavelet feature extracting unit which applies the Gabor wavelet feature set to an input image to extract Gabor wavelet features from the input image; and
a face descriptor generating unit which generates a face descriptor by using the constructed Gabor wavelet feature set and the Gabor wavelet features extracted by the second Gabor wavelet feature extracting unit.

21. The face descriptor generating apparatus of claim 20, further comprising a basis vector generating unit which generates basis vectors by performing a LDA learning process on the constructed Gabor wavelet feature set, wherein the face descriptor generating unit generates the face descriptor by using the Gabor wavelet features extracted by the second Gabor wavelet feature extracting unit and the basis vectors.

22. The face descriptor generating apparatus of claim 20, wherein the selecting unit comprises:
a subset dividing part which divides the Gabor wavelet features extracted by the first Gabor wavelet feature extracting unit into subsets; and
a learning part which performs a parallel boosting learning process on the divided subsets to select the Gabor wavelet features.

23. The face descriptor generating apparatus of claim 21, wherein the basis vector generating unit comprises:
a kernel center selecting part which selects kernel centers from the Gabor wavelet feature set;
a first inner product part which generates first feature vectors by performing inner product of the Gabor wavelet feature set with the kernel centers; and
a linear discriminant analysis learning part which generates basis vectors by performing a linear discriminant analysis learning process on the generated first feature vectors.

24. The face descriptor generating apparatus of claim 23, further comprising a second inner product part which extracts second feature vectors of the input image by performing inner product of the kernel center selected by the kernel center selecting part with the Gabor wavelet features extracted by the second Gabor wavelet feature extracting unit,
wherein the face descriptor generating unit generates the face descriptor by projecting the second feature vectors extracted by the second inner product part onto the basis vectors.

25. A face recognition apparatus comprising:
a Gabor wavelet feature extracting unit which applies an extended Gabor wavelet filter to a training face image to extract extended Gabor wavelet features from the training face image;
a selecting unit which performs a supervised learning process for face-image-classification on the extracted Gabor wavelet features to select the Gabor wavelet features and constructs a Gabor wavelet feature set including the selected Gabor wavelet features;
an input-image Gabor wavelet feature extracting unit which applies the constructed Gabor wavelet feature set to an input image to extract the Gabor wavelet features from the input image;
a target-image Gabor wavelet feature extracting unit which applies the constructed Gabor wavelet feature set to a target image to extract the Gabor wavelet features from the target image;
a face descriptor generating unit which generates face descriptors of the input image and the target images by using the Gabor wavelet features of the input image and the target image; and
a similarity determining unit which determines whether or not the face descriptors of the input image and the target image have a predetermined similarity.
